(19) United States
(12) Patent Application Publication
(10) Pub. No.: US 2009/0192946 A1
(43) Pub. Date: Jul. 30, 2009

(54) Electronic financing and collateralization method for securities

(76) Inventor: David Buckmaster, New York, NY (US)

Correspondence Address: Peter S. Canelias;Law Offices of Peter S. Canelias, Suite 2148, 420 Lexington Avenue, New York, NY, 10170, US

(21) Appl. No.: 12/011,948

(22) Filed: Jan. 30, 2008

(51) Int. Cl. G06Q 40/00

(52) U.S. Cl. 705/36 R; 705/37

(57) ABSTRACT

This process is designed to supplement current financing methods for general collateral with a secure vehicle (Collateral Receipt) that can be delivered vs. payment via the Federal Reserve's Book Entry system and or through the Depository Trust Company. It is further designed to allow for the Collateral Receipt to be fully netting eligible by FICC without the requirement that cash providers agree to clearing fund requirements or mutualization of loss. A Collateral Receipt would be an obligation issued by an organization such as a registered clearing corporation which would represent ownership in a pool of collateral that is priced and maintained by that organization. The process involves calculating a collateral value for the securities issue using an initial price, electronically delivering the instructions to a clearing bank, transmitting a value of the securities issue to an issuer, whereupon the issuer issues a collateral receipt in exchange for the securities issue.

### BACKGROUND OF THE INVENTION

The invention relates to the financing of securities. Major dealers both in the United States and around the world maintain positions in a wide variety of securities including U.S. Treasuries, Foreign Sovereign Debt, Government Sponsored Enterprise Agency issues, Mortgage-backed securities, Asset backed Securities, Corporate Bonds, Equities and whole loans among others. The dealers maintain these positions in connection with their functions as liquidity providers for the various financial products.

Although many of these dealers have substantial capital of their own, the positions that they carry are enormous by comparison and it is necessary for them to find financing from various sources. The financing is done in various ways including bank loans, broker loans, delivery vs. payment repurchase agreements and tri-party repurchase agreements. The different products tend to gravitate to and cluster around one or other of these sources but dealers now utilize tri-party repurchase agreements to help finance virtually all products.

Tri-party repurchase agreements call for the participation of an independent “honest broker” in the middle of financing transactions between a funds lender (money market mutual funds, securities lending firms, asset manages, etc.) and a funds borrower (generally a dealer). This “honest broker” is almost always a clearing bank at which the dealers maintain significant securities positions. These organizations step in as a custodial agent for the lender and borrower and assure that neither has simultaneous possession of both the cash and the collateral associated with a transaction.

As of this writing it is estimated that average total tri-party financing in the United States alone exceeds $2 trillion each day. Although tri-party financing has served the industry well since the early 1980s, such loans have been limited to organizations where there is a concentration of dealer clearance. These clearing organizations have had to develop very sophisticated collateral allocation and pricing mechanisms. This, coupled with the fact that virtually all of the activity is collateralized after the various clearing mechanisms (e.g. the Federal Reserve's Book Entry system and DTC) have closed, makes it extremely difficult for any other organizations to participate.

Inherent in the current tri-party business are risks that have not yet been fully mitigated. One risk is that one of the tri-party custodian banks might have a credit or legal problem that would make them a less than desirable location for cash deposits. Since the vast majority of cash that is invested in tri-party loans remains in demand deposit accounts at the custodian banks during the day, there is a concern that given such a negative credit event the lenders would not be willing to do financing transactions with dealers which clear in that institution. This could have a severe impact on the liquidity of the markets and the ability of the various issuers of debt instruments (including the U.S. Treasury) to bring those securities to market. Regulators have been pursuing a back-up plan to help eliminate the possibility of such a disruption and have assigned the Securities Industry Financial Markets Association the task of creating this vehicle normally referred to as “NewBank”.

There is also risk in that there are a significant number of funds transfers that must be processed through various systems each day, many very late in the day. Given a total tri-party market of $2 trillion and the fact that 5-10% of that amount is moved around every day, it is estimated that $100 to $200 billion is moved through computerized electronic funds transfer systems daily. Although the controls around such electronic transfers are extensive, it is always preferable to avoid the actual movement of cash or to operate within a system that requires a simultaneous exchange of something of value for the cash as is done with securities vs. payment transactions through the Federal Reserve's computerized book entry system.

One disadvantage for dealers is that the tri-party repurchase agreements (repos) into which they enter are not processed through or guaranteed by the Government Securities Division of the Fixed Income Clearing Corporation (FICC) and therefore are not eligible for balance sheet netting. Tri-party lenders have not been willing to join FICC as that would require them to put up clearing fund collateral and would make them subject to mutualization of loss in the event of a dealer default.

The following novel financing method, called Collateral Receipt Financing, has been designed to broaden the number of participants while at the same time eliminating much of the systemic risk associated with the large volume of unsecured deposits held by banks intra-day as well as other risks involved in the financing of dealer's collateral. It has also been designed so as to allow transactions in the product to be fully netting eligible by FICC without the need for the funds providers to post any margin or accept any responsibility for mutualization of loss. Utilizing the proposed process would allow any funds provider that chooses to join such an arrangement to eliminate the movement of any funds related to the transfer of a loan from one dealer to another. As long as all of its counterparties are netting members of the arrangement, only the net change in their overall investment would require the receipt or delivery of a Collateral Receipt. Dealers will benefit because any transactions with any cash providers will be eligible for balance sheet netting.

### BRIEF SUMMARY OF THE INVENTION

This process is designed to replace current financing methods for general collateral with a secure vehicle (Collateral Receipt) that can be delivered vs. payment via the Federal Reserve's Book Entry system and or through the Depository Trust Company. It is further designed to allow for the Collateral Receipt to be fully netting eligible by FICC without the requirement that cash providers agree to clearing fund requirements or mutualization of loss.

A Collateral Receipt would be an obligation issued by an organization such as a registered clearing corporation which would represent ownership in a pool of collateral that is priced and maintained by that organization. One organization that could act in this role is the FICC, a subsidiary of the Depository Trust Company. For purposes of this embodiment, FICC will be utilized but any organization that is acceptable to the dealers and investors could perform this role. In order to fully take advantage of balance sheet netting however, utilization of an existing central counterparty such as FICC for netting and settlement would be preferred.

In order to create the Collateral Receipt, any entity that wishes to finance collateral of any kind would transfer the collateral to FICC. Collateral Receipts will be issued in exchange for generic pools of collateral that are compliant with the collateral acceptable for the generic CUSIP's utilized within FICC's General Collateral Financing (GCF) system. Additional generic pool requirements can be created to accommodate any securities (e.g. equities) that are not currently handled within FICC's GCF system.

FICC will price the collateral and issue a Collateral Receipt in an amount equal to the market value of the collateral to the party that presented the collateral. The Collateral Receipt will not bear interest but will be a direct obligation of FICC which can be presented back to FICC by the organization that requested its issuance in exchange for the supporting collateral. In the event of the default of any organization that had requested issuance of Collateral Receipts, FICC would have the ability to liquidate the pool of collateral and generate cash which could be utilized to redeem the Collateral Receipts.

Key to the guaranty feature of FICC, each Collateral Receipt would have a fixed redemption price which would be based upon the volatility of the collateral and would therefore equate to normal margin rates required within the tri-party financing structure. For example, a Collateral Receipt issued for Treasuries might have a fixed redemption price of 98 which would allow for a normal margin rate of 2%.

The securities will be under the control of FICC but will be accessible to the dealer for delivery purposes during the day in exchange for cash or a security that satisfies the requirements of the Collateral Receipt and is of at least equal value. Both of the main clearing banks (Bank of New York Mellon and JPMorgan Chase) have sophisticated technology and would be capable of creating automatic substitution systems for the dealers to allow for this without impacting the smooth flow of deliveries. Principal and interest payments on securities held in this matter could either be paid directly to FICC or a transfer could be made before the opening of the securities wire that would transfer cash or eligible securities from the dealer to FICC in an amount sufficient to allow the payments to go directly to the dealer when received.

Any organization that that does not clear at either of the two main clearing banks which has created Collateral Receipts could request any previously assigned collateral be delivered to them vs. payment or could send in substitute securities in exchange.

After receiving the afternoon pricing, FICC will re-price all collateral held for each participant that requested issuance of securities and, if necessary, require that the participant add cash or additional collateral to support any shortfall in the value of the collateral supporting the Collateral Receipts. If the value of the collateral has increased, the entity that had requested the issuance of the Collateral Receipt could request return of collateral with a market value equal to the amount of such increase.

Once the Collateral Receipt has been issued the organization that had requested it will be able to utilize it as collateral for financing transactions. Trades could be executed on a bi-lateral basis or through the brokers screen on a blind basis.

As indicated above, there will be a fixed price used for each Collateral Receipt which would be set based upon agreed discounts (haircuts) within the industry for the product involved. For example, a Collateral Receipt issued for Government Securities might have a fixed price of 98 which would account for a normal margin requirement of 2% while a Collateral Receipt supported by Equities might have a fixed price of 90 allowing for 10% margin. This fixed price will also represent the amount that the issuer (FICC in this example) will guaranty to pay to redeem the Collateral Receipt in the event of the default of any dealer.

Important to this concept is that there would be agreement between the lenders and borrowers utilizing this product that all movements required across the delivery systems would be done against payment on a net basis.

It is hoped at this time that these would be eligible for delivery through Depository Trust Co. (DTC) (a private depository bank for institutions and brokerage firms and the Federal Reserve's book entry system (Fed Wireable) but would not be subject to the $50 million maximum size restriction currently in place in the Fed's system. In order to keep the absolute number of deliveries to a minimum, given the trillions in financing that could be processed in this manner, a maximum size limit of $950 million with an industry agreed practice that any multiple of $50 million is acceptable as a partial would be preferable but not necessary. To the extent that a netting system is utilized, the number of movements through the system would be minimized.

The netting system for Collateral Receipts preferably would function in much the same way as that utilized by FICC for GCF transactions. The major difference is that the only securities that would be eligible for netting within the system would be Collateral Receipts that were issued by FICC.

The values of the Collateral Receipts are fixed and the collateralization is under the control of FICC which has recourse to the dealer. Given the fact that there are no securities valuation issues and the fact that the funds providers would always be in a situation where they would be receiving a payment as a result of the net it would not be necessary for non dealer members to provide clearing funds or participate in mutualization of loss. This could be accomplished by allowing funds providers to submit only reverse repurchase agreements for Collateral Receipts to the system.

Netting would take place once each day at a time that is late enough in the day to capture virtually all transactions but early enough to allow for participants to complete any necessary deliveries. For example, the time for netting might be set at 1:30 p.m. EST which would allow enough time for the netting process and notification of obligations while still allowing at least an hour for delivery to take place over the Fed system.

All receive and deliver obligations that come out of the net could be at the fixed value and not include interest or they could come out with the interest included in the delivery value dependent on the design of the netting system. If handled separately, the interest amounts along with any fees or other residual amounts could be satisfied utilizing the Federal Reserve Bank's National Settlement Service (NSS) system similar to the way settlement is done for DTC and FICC today.

Given the net, the cash investors would be able to eliminate most of the movement of cash and would only have a receive or a deliver obligation if they were changing the absolute amount that they had invested in Collateral Receipts on any given day. This system could also be designed to allow for FICC to transmit any residual receive or deliver instructions required for the cash investors directly to whatever custodian that they may choose.

If FICC is utilized as the central counterparty, the transactions should be eligible for balance sheet netting against all other transactions that a dealer may have with FICC. Other advantages of this financing method will be more fully apparent from the following disclosure and appended claims.

### DETAILED DESCRIPTION

To better understand the present invention, the following embodiment is expressed in terms of sample transaction flows. For transactions that are processed with a participant that chooses not to be a member of a netting system the following is a description of how transactions would flow through a computer network.

The collateral receipt process would benefit the various parties involved as follows:

### Dealers:

Balance sheet netting for investor financing trades

Given a guaranty by a central counterparty, should allow for lower financing rates for less credit worthy collateral.

Less daylight overdraft charges due to elimination of funds transfers associated with tri-party

Ability to net all financing transactions between different funds providers

Continued access to all of their collateral for delivery purposes

Eliminates the need to establish and maintain numerous tri-party custodial agreements.

Eliminates the need to create, staff and fund NewBank

### Investors:

They have possession of securities all day eliminating deposit risk

The ability to do a multi-lateral net of all their reverse repo transactions

They will have the benefit of FICC's guaranty on all transactions

The ability to trade more freely without consideration of operational problems associated with switching their investing partners.

Eliminates the need for custodial tri-party agreements

### Clearing Banks:

New business of maintenance of Collateral Receipt collateral on behalf of dealers and FICC

Eliminates a large percentage of the intra-day credit exposure that currently exists with dealers

Virtually eliminates all of the maintenance and problems associated with tri-party transactions

Eliminates many late day funds transfers allowing for better cash management

Eliminates the need for programming and maintenance to support NewBank Federal Reserve:

Less cash movements late in the day being processed through its funds system

Provides a decrease in systemic risk in that dealers no longer need to be protected from problems associated with concentration of tri-party activity.

Provides a decrease in systemic risk as cash investors are no longer exposed to the risk associated with cash deposits sitting in an unsecured demand deposit account.

Allows for an increase in the number of transactions in the Fed's book-entry system

### DTCC:

Generates a new product and revenue source for FICC

Allow DTC members to gain more ready access to the financing markets

Supports overall objective of providing service and security to the investor and banking community

### Collateral Receipt Transaction Flow Embodiment

The following portrays the transaction flow that would take place if collateral receipts were utilized for financing either directly between the dealer and investor or if the transaction is processed through a central counterparty.

For purposes of this flow it is assumed that the Fixed Income Clearing Corporation (FICC) is both the issuer and the central counterparty. It is important to note that it is not necessary for FICC to be the issuer. Any entity that has the confidence of the dealer and investment community could be the issuer if they were willing to invest in the technology and systems infrastructure required. Indeed, the financial community could create a new industry-owned utility for this purpose if it so chooses.

The issuer of the collateral receipts will have available each morning current prices for all securities that are eligible for any given receipt. These prices may or may not be made available for query by the clearing banks and/or dealers at the preference of those involved. To simplify this transaction flow embodiment, a very limited number of securities issues and counterparties will be utilized while in reality there are tens of thousands of securities positions and hundreds of counterparties.

The issuer of the collateral receipts will have stipulated the exact requirements for all securities which are eligible for inclusion in any particular collateral receipt. For this example a collateral receipt will be utilized which will be identified as being supported by U.S. Treasury securities maturing in 30 years or less. The securities eligible for inclusion in this receipt will be U.S. Treasury Bills, Bonds and Notes. It will be identified as an FICC Collateral Receipt for Treasuries due in 30 years or less with a guaranteed redemption price of 98. The designation “FCR TR 30-98” will be utilized to define this issue.

On Oct. 19, 2007, as a result of transactions that have occurred during the day Dealers A and B have the following securities positions which they wish to finance:

### Dealer A

$150,000,000 face value U.S. Treasury Bills due Ja. 3, 2008
$100,000,000 face value U.S. Treasury Notes 4.50% due Sep. 30, 2011
$75,000,000 face value U.S. Treasury Bonds 4.50% due Feb. 15, 2036

### Dealer B

$250,000,000 face value U.S Treasury Bills due Apr. 17, 2008
$200,000,000 face value U.S. Treasury Notes 4.125% due Aug. 15, 2008
$300,000,000 face value U.S. Treasury Notes 4.75% due Feb. 15, 2010
$100,000,000 face value U.S Treasury Bonds 6.00% due Feb. 15, 2026

The prices for these issues that have been posted by FICC for utilization in the issuance of Collateral Receipts are as follows:

| SECURITY | PRICE |
|---|---|
| U.S. Treasury Bill due Jan. 03, 2008 | 3.69 |
| U.S Treasury Bill due Apr. 17, 2008 | 3.93 |
| U.S. Treasury Note 4.125% due Aug. 15, 2008 | 100-00 |
| U.S. Treasury Note 4.75% due Feb. 15, 2010 | 102-00 |
| U.S. Treasury Note 4.50% due Sep. 30, 2011 | 101-30 |
| U.S Treasury Bond 6.00% due Feb. 15, 2026 | 115-05 |
| U.S. Treasury Bond 4.50% due Feb. 15, 2036 | 96-28 |

Utilizing these prices from the morning of Oct. 19, 2007 the collateral value including accrued interest of the various dealer positions would be as follows (all collateral values in this example are rounded down to the nearest thousand):

| | Collateral |
|---|---|
| Dealer A Positions | Value for Oct. 19, 2007 |
| $150,000,000 Bills due Jan. 03, 2008 | $148,831,000 |
| $100,000,000 Notes 4.50% due Sep. 30, 2011 | $102,171,000 |
| $75,000,000 Bonds 4.50% due Feb. 15, 2036 | $73,252,000 |
| Total Value | $324,254,000 |

| | Collateral |
|---|---|
| Dealer B Positions | Value for Oct. 19, 2007 |
| $250,000,000 Bills due Apr. 17, 2008 | $245,060,000 |
| $200,000,000 Notes 4.125% due Aug. 15, 2008 | $201,457,000 |
| $300,000,000 Notes 4.75% due Feb. 15, 2010 | $308,516,000 |
| $100,000,000 Bonds 6.00% due Feb. 15, 2026 | $116,216,000 |
| Total Value | $871,249,000 |

Dealers A and B both have business relationships with Investors 1, 2 and 3 and will negotiate with them to finance their positions. Investors 1 and 2 are netting members of FICC. Investor 3 is not a member of FICC and operates on a delivery vs. payment basis. Dealer A has a clearing relationship with First Clearing Bank. Dealer B has a relationship with Second Clearing Bank. The following numbered transaction steps follow the flow of transactions within a typical time frame.
1) During the day of Oct. 19, 2007 as the positions become available they are delivered electronically by the dealers to FICC within their respective clearing bank in exchange for FICC Collateral receipts. FICC utilizes its systems to confirm the market values.
Dealer A delivers a total of $324,254,000 collateral to FICC at First Clearing Bank.
FICC delivers $324,254,000 “FCR TR 30-98” back to Dealer A at First Clearing Bank.
Dealer B delivers a total of $871,249,000 collateral to FICC at Second Clearing Bank.
FICC delivers $871,249,000 “FCR TR 30-98” back to Dealer B at Second Clearing Bank
   2) As this is effectively “Day One” of the process, assume that the following transactions take place too late to be included in the afternoon net of FICC and must be delivered vs. payment to the Investors.

The Dealers arrange the following “overnight” financings of the FCR TR 30-98 until Monday Oct. 22, 2007 from Investors as indicated—all investors have agreed that the price that they are willing to utilize to calculate the amount of funds they are willing to lend is equal to the price that FICC has set as the redemption value −98:

### Dealer A

$220,000,000 with Investor 1 at a rate of 4.75%
$100,000,000 with Investor 2 at a rate of 4.76%.
(Assume that the remainder of $3,254,000 FCR TR 30-98 remains in the dealer position and is financed utilizing the dealer's capital).

### Dealer B

$400,000,000 with Investor 1 at a rate of 4.75%
$300,000,000 with Investor 2 at a rate of 4.76%
$170,000,000 with Investor 3 at a rate of 4.74%
(Assume that the remainder of $1,249,000 FCR TR 30-98 remains in the dealer position and is financed utilizing the dealer's capital).
Dealer A delivers $220,000,000 FCR TR 30-98 to Investor 1 vs. $215,600,000
Dealer A delivers $100,000,000 FCR TR 30-98 to Investor 2 vs. $98,000,000
Dealer B delivers $400,000,000 FCR TR 30-98 to Investor 1 vs. $392,000,000
Dealer B delivers $300,000,000 FCR TR 30-98 to Investor 2 vs. $294,000,000
Dealer B delivers $170,000,000 FCR TR 30-98 to Investor 3 vs. $166,600,000

The deliveries above are made through the Federal Reserve's Book Entry System or through DTC utilizing normal dealer clearance procedures.
3) As prices become available in the late afternoon, FICC electronically obtains new prices for the collateral that supports the Collateral Receipts that it has issued:

| SECURITY | NEW PRICE |
|---|---|
| U.S. Treasury Bill due Jan. 03, 2008 | 3.70 |
| U.S Treasury Bill due Apr. 17, 2008 | 3.98 |
| U.S. Treasury Note 4.125% due Aug. 15, 2008 | 99-28 |
| U.S. Treasury Note 4.75% due Feb. 15, 2010 | 101-24 |
| U.S. Treasury Note 4.50% due Sep. 30, 2011 | 101-22 |
| U.S Treasury Bond 6.00% due Feb. 15, 2026 | 115-00 |
| U.S. Treasury Bond 4.50% due Feb. 15, 2036 | 96-20 |

4) FICC utilizes these prices to calculate the new value of the collateral that had been delivered to it by the dealers:

| Dealer A Positions | New Collateral Value |
|---|---|
| $150,000,000 Bills due Jan. 03, 2008 | $148,874,000 |
| $100,000,000 Notes 4.50% due Sep. 30, 2011 | $101,957,000 |
| $75,000,000 Bonds 4.50% due Feb. 15, 2036 | $73,092,000 |
| Total Value | $323,923,000 |

| Dealer B Positions | New Collateral Value |
|---|---|
| $250,000,000 Bills due Apr. 17, 2008 | $245,080,000 |
| $200,000,000 Notes 4.125% due Aug. 15, 2008 | $201,274,000 |
| $300,000,000 Notes 4.75% due Feb. 15, 2010 | $307,883,000 |
| $100,000,000 Bonds 6.00% due Feb. 15, 2026 | $116,108,000 |
| Total Value | $870,345,000 |

5) FICC then compares the collateral value to the amount of Collateral Receipts outstanding:

| | Collateral Receipts | | Collateral |
|---|---|---|---|
| | Outstanding | Collateral Value | Surplus/(Shortfall) |
| Dealer A | $324,254,000 | $323,923,000 | ($331,000) |
| Dealer B | $871,249,000 | $870,345,000 | ($904,000) |

6) FICC electronically notifies the dealers of their shortfalls and requires them to either return Collateral Receipts to be retired or submit additional acceptable collateral. Dealer A opts to return $331,000 in Collateral Receipts while Dealer B decides to send an additional $923,000 U.S. Treasury Bills due Apr. 17, 2008 which have a market value of $904,836.

| | Collateral Receipts | | Collateral |
|---|---|---|---|
| | Outstanding | Collateral Value | Surplus/(Shortfall) |
| Dealer A | $323,923,000 | $323,923,000 | 0 |
| Dealer B | $871,249,000 | $871,249,000 | 0 |

### END of DAY Friday, Oct. 19, 2007

### Transactions of Monday, Oct. 22, 2007

7) The dealers had executed the following purchase and sale transactions for settlement on 10-22-77:

### Dealer A

Sold $50,000,000 Bills due Jan. 3, 2008
Purchased $50,000,000 Bills due Dec. 12, 2007

### Dealer B had no Purchase or Sale Activity.

8) Dealer A transmits an instruction to First Clearing Bank to deliver $50,000,000 Bills due Jan. 3, 2008 to Customer A vs. payment. First Clearing Bank electronically checks Dealer A's account to see if it is holding the securities in its clearance account. Assuming that Dealer A does not hold any in its account, First Clearing Bank will then electronically check to see if the securities are held as collateral for FICC. When it finds that sufficient position exists within FICC's account it will automatically set up a transfer vs. payment from FICC to Dealer A in an amount equal to the value of the collateral as FICC knows it and then completes the deliver to Customer A:
FICC delivers $50,0000,000 Bills due Jan. 3, 2008 to Dealer A vs. $49,625,000
Dealer A delivers $50,000,000 Bills due Jan. 3, 2008 to Customer A vs. payment
   9) Dealer A then receives $50,000,000 Bills due Dec. 27, 2007 from Customer B against payment. The price that FICC has for this issue for settlement is 3.73. Dealer A wishes to continue to maintain the same level of Collateral Receipts outstanding so it delivers sufficient market value of the Dec. 27, 2007 Bills to FICC to retrieve the cash payment of $49,625,000 it had made to FICC in exchange for the Bills due Jan. 3, 2008:
Dealer A receives $50,000,000 Bills due Dec. 27, 2007 from Customer B vs. payment
Dealer A deliver $49,967,000 Bills due Dec. 27, 2007 to FICC vs. $49,625,000
   10) The dealers have arranged the following financing for their positions on Oct. 22, 2007:

Dealer A
$150,000,000 with Investor 1 at a rate of 4.77% vs. $147,000,000
$150,000,000 with Investor 2 at a rate of 4.78% vs. $147,000,000
$20,000,000 with Investor 3 at a rate of 4.75% vs. $19,600,000

Dealer B
$500,000,000 with Investor 1 at a rate of 4.75% vs. $490,000,000
$230,000,000 with Investor 2 at a rate of 4.76% vs. $225,400,000
$140,000,000 with Investor 3 at a rate of 4.74% vs. $137,200,000
11) FICC had compared and guaranteed the transactions that had been executed between its members on the previous day (2 above) as well as the new transactions that were entered into between its members today (10 above). In the early afternoon, FICC will run their current netting process and generate the following obligations for the parties (the obligations from the prior day include the financing interest that applies to the transactions from Oct. 19, 2007 at the rates indicated in 2 above):

| | |
|---|---|
| Due to FICC from Investor 1 | $620,000,000 FCR TR 30-98 vs. |
| | $607,840,508.33 |
| Due to Investor 1 from FICC | $650,000,000 FCR TR 30-98 vs. |
| | $637,000,000.00 |
| Net due to Investor 1 from FICC | $30,000,000 vs. $29,159,491.67 |
| Due to FICC from Investor 2 | $400,000,000 FCR TR 30-98 vs. |
| | $392,155,493.33 |
| Due to Investor 2 from FICC | $380,000,000FCR TR 30-98 vs. |
| | $372,400,000.00 |
| Net due to FICC from Investor 2 | $20,000,000 vs. $19,755,493.33 |
| Due to Dealer A from FICC | $320,000,000 FCR TR 30-98 vs. |
| | $313,724,215.00 |
| Due to FICC from Dealer A | $300,000,000 FCR TR 30-98 vs. |
| | $294,000,000.00 |
| Net due to Dealer A from FICC | $20,000,000 vs. $19,724,215.00 |
| Due to Dealer B from FICC | $700,000,000 FCR TR 30-98 vs. |
| | $686,271,786.66 |
| Due to FICC from Dealer B | $730,000,000 FCR TR 30-98 vs. |
| | $715,400,000.00 |
| Net due to FICC form Dealer B | $30,000,000 vs. $29,128,213.34 |

12) Given the netting obligations created in step 11 above and the transactions with Investor 3 in steps 2 and 10 above, the various parties would have the following receive-and-deliver transactions in FCR TR 30-98 on Oct. 22, 2007:

### Dealer A

Receive from FICC $20,000,000 vs. $19,724,215.00
Deliver to Investor 3 $20,000,000 vs. $19,600,000.00

### Dealer B

Receive from Investor 3 $170,000,000 vs. $166,665,807.00
Deliver to Investor 3 $140,000,000 vs. $137,200,000.00
It is noted that in accordance with normal settlement practices, the two parties may agree to a bi-lateral “pair-off” the two transactions above which would give Dealer B a receive obligation of $30,000,000 vs. $29,465,807.00 from Investor 3.
Deliver to FICC $30,000,000 vs. $29,128,213.34

### Investor 1

Receive from FICC $30,000,000 vs. $29,159,491.67

### Investor 2

Deliver to FICC $20,000,000 vs. $19,755,493.33

### Investor 3

Receive from Dealer A $20,000,000 vs. $19,600,000.00
Receive from Dealer B $140,000,000 vs. $137,200,000.00
Deliver to Dealer B $170,000,000 vs. $166,665,807.00

### FICC

Receive from Dealer B $30,000,000 vs. $29,128,213.34
Receive from Investor 2 $20,000,000 vs. $19,755,493.33
Deliver to Dealer A $20,000,000 vs. $19,724,215.00
Deliver to Investor 1 $30,000,000 vs. $29,159.491.67

In keeping with its current procedures, FICC may choose to settle all transactions with counterparties at a uniform value and settle the cash difference separately.
13) FICC would obtain new prices and would repeat the process described in steps 3 through 6 above.

Since other modifications or changes will be apparent to those skilled in the art, there have been described above the principles of this invention in connection with specific apparatus, it is to be clearly understood that this description is made only by way of example and not as a limitation to the scope of the invention.

What is claimed is:

1. A computerized method of collateralizing financial transactions, comprising the steps of:
establishing an initial price for a securities issue and inputting the initial price into a computer system;
a dealer transmitting an instruction to a clearing bank to deliver the securities issue;
the clearing bank transmitting the securities issue to a collateral receipt issuer;
calculating and assigning a collateral value for the securities issue using the initial price;
calculating and assigning a guaranteed redemption value for the collateral receipt;
the issuer issuing a collateral receipt to the dealer in exchange for the securities issue where the collateral receipt has the guaranteed redemption value equal to the collateral value less a margin amount appropriate for the securities issue.

2. The method of claim 1, wherein the initial price is made available for query by the issuer.

3. The method of claim 1, wherein the collateral receipt is eligible for netting by a central counterparty.

4. The method of claim 1, further comprising steps of:
the issuer electronically obtaining a new price for the securities issue that supports the collateral receipt;
calculating a new collateral value using the new price;
comparing the new collateral value to a collateral receipt value;
transmitting an electronic notification to a dealer of a shortfall or excess between the new collateral value and the collateral receipt value.

5. The method of claim 4, further comprising a step of:
the dealer transmitting the collateral receipt to be retired in response to the electronic notification of a shortfall.

6. The method of claim 4, further comprising a step of:
the dealer transmitting additional collateral in response to the electronic notification of a shortfall.

7. The method of claim 4, further comprising a step of:
the issuer transmitting collateral to the dealer in response to the electronic notification of an excess.

8. The method of claim 4, further comprising a step of:
the issuer transmitting an additional collateral receipt to the dealer in response to the electronic notification of an excess.

9. A computerized method of maintaining adequate collateral value while allowing access to collateral, comprising the steps of:
a dealer transmitting a deliver instruction to a clearing bank to obtain delivery of a securities issue associated with a collateral receipt, where the securities issue is held as collateral;
the clearing bank electronically accessing a dealer clearance account associated with the dealer to determine if the securities issue is held in the dealer clearance account;
if the securities issue is not in the dealer's clearance account, electronically accessing an issuer's account maintained for the dealer, where an issuer has issued the collateral receipt associated with the securities issue;
determining if the securities issue is in the issuer's account,
determining a collateral value, where the collateral value is an amount of the securities issue required by the dealer;
comparing the collateral value of the securities issue with a collateral value of the collateral receipt;
if additional collateral is needed to equal the collateral value of the collateral receipt, the clearing bank transfers the additional collateral or cash from the dealer's clearing account to the issuer;
transferring the securities issue to the dealer.

10. The method of claim 9, wherein the collateral receipt is eligible for netting by a central counterparty.
